(19) United States
(12) Patent Application Publication
(10) Pub. No.: US 2025/0290868 A1
(43) Pub. Date: Sep. 18, 2025

(54) OPTICAL INSPECTION SYSTEM

(71) Applicant: BRIGHTEST TECHNOLOGY TAIWAN CO., LTD., HSINCHU COUNTY (TW)

(72) Inventors: CHENGWEI HSU, HSINCHU COUNTY (TW); KUO-FENG TSENG, SANTA CLARA, CA (US); ZHONGHUA DONG, SANTA CLARA, CA (US); PEI-CHI HUANG, HSINCHU COUNTY (TW); XIAOCHUN LI, SANTA CLARA, CA (US)

(21) Appl. No.: 19/073,038

(22) Filed: Mar. 7, 2025

Related U.S. Application Data
(60) Provisional application No. 63/566,665, filed on Mar. 18, 2024.

(51) Int. Cl. G01N 21/95

(52) U.S. Cl. CPC G01N 21/9501; G01N 2201/021; G01N 2201/06113; G01N 2201/0633; G01N 2201/0636

(57) ABSTRACT

An optical inspection system includes an optical device and an image processing device. The optical device includes a light source and an image sensor. The light source is configured to generate a first laser beam and direct the first laser beam through an illuminator to be an incident laser beam toward a wafer, so as to generate a reflected laser beam accordingly. The image sensor is configured to capture the reflected laser beam through an objective to be a second laser beam and generate an image of the wafer accordingly. The image processing device is configured to generate a detection result according to the image. A wavelength of the incident laser beam is less than 120 nm.

### TECHNICAL FIELD

The present application relates to a wafer inspection system, particularly to an optical inspection system using extreme ultraviolet (XUV) to inspect the semiconductor device.

### BACKGROUND

In modern semiconductor industry, the wafer inspection is critical in the manufacturing processes. However, due to the diminishing feature sizes and intricate patterns, the defect becomes smaller and more complicated, which results that the defect inspection becomes more challenging. Generally, smaller defect (e.g., the defect having a dimension below 20 nm) needs finer resolution for inspection, but the finer resolution needs the inspection light to have a shorter wavelength. Such short-wavelength light usually results in weaker signal strength, which lowers the inspection sensitivity and makes it difficult to obtain the desired capture rate and desired nuisance rate. However, inspection using short-wavelength light (e.g., extreme ultraviolet (XUV)) is highly sensitive to both thickness and material. When it comes to wafers with multi-layered structures, variations in materials or thicknesses (under short-wavelength light) can result in different inspection qualities (e.g., resolution). Besides, even with the use of short-wavelength light, low material contrast among the materials used on the wafers can make certain defects undetectable and decreases the signal-to-noise ratio (SNR) in detection. Furthermore, generating short-wavelength light introduces challenges such as conversion efficiency (or light intensity), bandwidth, polarization, spectral purity, resolution, or contamination management. These challenges are critical to the performance of light sources of semiconductor inspection equipment.

On the other hand, when the inspection sensitivity is increased, the throughput is decreased. Therefore, a new solution is needed to optimize the performance of the wafer optical inspection system.

### SUMMARY OF THE INVENTION

One aspect of the present disclosure provides an optical inspection system. The optical inspection system includes an optical device and an image processing device. The optical device includes a light source and an image sensor. The light source is configured to generate a first laser beam and direct the first laser beam through an illuminator to be an incident laser beam toward a wafer, so as to generate a reflected laser beam accordingly. The image sensor is configured to capture the reflected laser beam through an objective to be a second laser beam and generate an image of the wafer accordingly. The image processing device is configured to generate a detection result according to the image. A wavelength of the incident laser beam is less than 120 nm.

Another aspect of the present disclosure provides an optical inspection system. The optical inspection system includes an optical device and an image processing device. The optical device includes a light source and an image sensor. The light source is configured to generate a first laser beam and direct the first laser beam through an illuminator to be an incident laser beam toward a wafer, so as to generate a reflected laser beam accordingly. The light source includes a first wavelength converting channel, a second wavelength converting channel, an XUV generator. The first wavelength converting channel is configured to generate a first EUV laser. The second wavelength converting channel is configured to generate a second EUV laser. The XUV generator is configured generate the first laser beam according to the first EUV laser or the second EUV laser. The image sensor is configured to capture the reflected laser beam through an objective to be a second laser beam and generate an image of the wafer accordingly. The image processing device is configured to generate a detection result according to the image.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1 is a schematic diagram of an optical inspection system according to some embodiments of the present disclosure.

FIG. 2A is a schematic diagram of an optical device according to some embodiments of the present disclosure.

FIG. 2B is a schematic diagram of a light source according to other embodiments of the present disclosure

FIG. 3 is a schematic diagram of an optical device according to some embodiments of the present disclosure.

FIG. 4 is a schematic diagram of a de-speckler according to some embodiments of the present disclosure.

FIG. 5A is a schematic diagram of a homogenizer according to some embodiments of the present disclosure.

FIG. 5B is a schematic diagram of laser transmission between a homogenizer 114 a condenser according to some embodiments of the present disclosure.

FIG. 6A is a schematic diagram of a homogenizer according to other embodiments of the present disclosure.

FIG. 6B is a cross-sectional diagram of a homogenizer according to other embodiment of the present disclosure.

FIG. 6C is a cross-sectional diagram of a homogenizer according to other embodiment of the present disclosure.

FIG. 6D is a cross-sectional diagram of a homogenizer according to other embodiment of the present disclosure.

FIG. 7 is a schematic diagram of a homogenizer according to various embodiments of the present disclosure.

FIG. 8 is a schematic diagram of a relay according to some embodiments of the present disclosure.

FIG. 9 is a schematic diagram of an objective according to some embodiments of the present disclosure.

FIG. 10A and FIG. 10B are schematic diagrams of field of views of an illuminator, an objective, and an image sensor according to some embodiments of the present disclosure.

FIG. 11 is schematic diagram of an image processing device according to some embodiments of the present disclosure.

FIG. 12 is a schematic diagram of an inspection platform according to some embodiments of the present disclosure.

FIG. 13 is a schematic diagram of a host computer according to some embodiments of the present disclosure.

FIG. 14 is a schematic diagram of motion controlling during an operation phase according to some embodiments of the present disclosure.

FIG. 15 is a schematic diagram of the synchronization of illumination, image sensing, and wafer's position according to some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the normal deviation found in the respective testing measurements. Also, as used herein, the terms “substantially,” “approximately,” or “about” generally mean within a value or range which can be contemplated by people having ordinary skill in the art. Alternatively, the terms “substantially,” “approximately,” or “about” mean within an acceptable standard error of the mean when considered by one of ordinary skill in the art. People having ordinary skill in the art can understand that the acceptable standard error may vary according to different technologies. Other than in the operating/working examples, or unless otherwise expressly specified, all of the numerical ranges, amounts, values and percentages, such as those for quantities of materials, durations of times, temperatures, operating conditions, ratios of amounts, and the likes thereof disclosed herein, should be understood as modified in all instances by the terms “substantially,” “approximately,” or “about.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as from one endpoint to another endpoint or between two endpoints. All ranges disclosed herein are inclusive of the endpoints, unless specified otherwise.

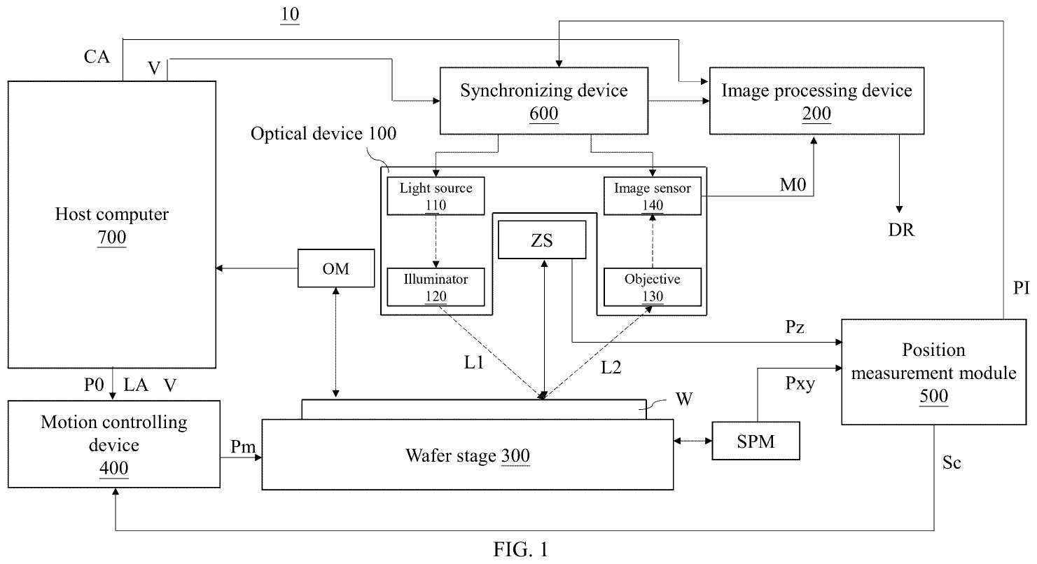

FIG. 1 is a schematic diagram of an optical inspection system 10 according to some embodiments of the present disclosure. The optical inspection system 10 is utilized to inspect a wafer W for determining whether the wafer W satisfies specific requirements.

In some embodiments, the optical inspection system 10 is configured to detect the defects on the wafer W. Furthermore, the optical inspection system 10 is configured to determine whether the dimensions, shapes, kinds, densities, and positions of detected defects are within the tolerance and satisfies the specification requirements of the wafer W. In some embodiments, the optical inspection system 10 is able to detect a defect which has a dimension smaller than 100 nm. In some embodiments, the optical inspection system 10 is configured to detect a defect which has a dimension about 10 nm to 20 nm.

In some embodiments, the optical inspection system 10 is utilized to inspect the wafer W after a lithography process. For example, the optical inspection system 10 inspects the photoresist and oxide's pattern on the wafer W after a photoresist layer is developed. In some embodiments, the optical inspection system 10 is utilized to inspect the wafer W after an etching process. For example, the optical inspection system 10 inspects the hard mask on the wafer W after a mask layer is patterned. In some embodiments, the optical inspection system 10 is utilized to inspect the wafer W after a metal deposition process. For example, the optical inspection system 10 inspects M0, M1, M2, M3, and/or M4 layer of the wafer W after a metal is deposited.

The optical inspection system 10 includes an optical device 100, an image processing device 200, a wafer stage 300, a motion controlling device 400, a position measurement module 500, a synchronizing device 600, a host computer 700, a spatial position measurement SPM, a Z sensor ZS, and an optical microscope OM.

The optical device 100 is configured to magnify the image of the wafer W to generate an image M0. The optical device 100 generates a laser beam L1 having a predetermined properties toward a region of interest of the wafer W and capturing an image M0 by receiving the reflected/scattered laser beam L2 from the region of interest of wafer W.

The image processing device 200 is configured to process the captured image M0 and perform the defect detection and classification so as to generate a detection result DR.

The wafer stage 300 is configured to bear and move the wafer W. In some embodiments, the wafer stage 300 is also referred to as an XYZ stage, namely, the wafer stage 300 is able to move along the X axis, Y axis, Z axis, or the combination thereof.

During the inspection, the wafer W is controlled to move along a predetermined inspection path P0 so that the laser beam L1 aiming at the same spot can scan the wafer W along the predetermined inspection path P0. Specifically, the motion controlling device 400 is configured to control the wafer stage 300 so as to align a moving path Pm of the wafer W with the predetermined inspection path P0.

However, in real world, mechanical devices can have various kinds of vibration during operation. The vibration may be caused by a running of a motor, particles on a track, or any other suboptimal conditions. Similarly, the instant optical inspection system 10 also incurs vibrations that introduce an offset between the moving path Pm and the predetermined inspection path P0, in which the offset may cause noise to the detection result. Therefore, the spatial position measurement SPM is configured to obtain a position Pxy of the wafer W during the inspection. The Z sensor ZS is configured to obtain a relative position Pz of the wafer W during the inspection. The position Pxy and the position Pz coindicate a position of the wafer W defined in a stage coordinate system. The motion controlling device 400 controls the wafer stage 300 to move the wafer W according to the stage coordinate system.

The position measurement module 500 is configured to obtain the position Pxy and the position Pz of the wafer W to determine whether the wafer W is deviated from the predetermined inspection path P0. When an offset between the moving path Pm of the wafer W and the predetermined inspection path P0 is greater than a predetermined threshold, the position measurement module 500 generates a calibration signal Sc to the motion controlling device 400, and the motion controlling device 400 is configured to adjust the moving path Pm of the wafer W according to the calibration signal Sc. In addition, the synchronizing device 600 for synchronizing the timings of illumination, the sensing and the movement of the wafer W is operated according to an image coordinate system different from the stage coordinate system. Thus, the position measurement module 500 is further configured to convert the position Pxy and the position Pz to a position P1 of the wafer W defined in the image coordinate system, and transmit the position P1 to the synchronizing device 600 for the following operations.

Because the image M0 is generated by optics, a depth of focus (DOF) has to be taken into concern. The position measurement module 500 is configured to obtain a difference between the image plane and the wafer W according to the position Pz obtained by the Z sensor ZS. When the difference between the image plane and the wafer W exceeds a tolerance, the position measurement module 500 uses the calibration signal Sc to inform the motion controlling device 400, and the motion controlling device 400 is configured to adjust the position Pz of the wafer W in response to the calibration signal Sc. Specifically, the motion controlling device 400 controls the wafer stage 300 to raise the wafer W higher or to drop the wafer W lower.

The synchronizing device 600 is configured to synchronize a timing of generating the laser beam L1 generated by the light source 110 of the optical device 100 and a timing that the image sensor 140 of the optical device 100 captures the laser beam L2 according to the position P1. According to the position P1, the synchronizing device 600 may determine a timing when the region of interest of the wafer W is arrived a desired position of the predetermined inspection path P0, and trigger the optical device 100 to generate the laser beam L1 to irradiate the region of interest. The synchronizing device 600 may further control the optical device 100 to capture the laser beam L2 at the corresponding timing. Therefore, the optical device 100 is able to capture the image M0 of the region of interest of the wafer W at the desired timing with the desired illumination.

The host computer 700 is configured to set the predetermined inspection path P0, control a loading angle LA of the wafer W so as to control an orientation of the wafer W with respect to the predetermined inspection path P0, determine a calibration algorithm CA for the image processing device 200, and determine a moving speed V of the wafer W for motion controlling device 400 and the synchronizing device 600 to synchronize the moving of the wafer W and the generation of the image M0. In some embodiments, the moving speed V is ranged from 0.1 mm/s to 100 mm/s.

The host computer 700 is also configured to set up the recipe according to different inspection conditions.

The optical microscope OM is configured to check whether the wafer W is controlled to have a desired orientation. In some embodiments, the optical microscope OM is used to check whether a notch of the wafer W is align with a specific direction. When the notch of the wafer W is not align with the specific direction, the host computer 700 may adjust the predetermined inspection path P0 or the loading angle LA according to the current orientation of the wafer W.

In some embodiments, the optical inspection system 10 is able to inspect 20% of wafer area within an hour using 10 nm pixel size, which requires the image data channel to handle a data rate at least equal to 40 G pixel/s. With a 10 nm to 50 nm image pixel size and a pulse rate of the laser beam L1 up to 2 MHz, the synchronizing device 600 should be able to provide a pulse period (calibrated synchronization timing) equal to 0.5 μs to the light source 110 and the image sensor 140.

In some embodiments, the spatial position measurement SPM has a position data refresh rate greater than 5 MHz, and a latency of data link from the spatial position measurement SPM to the synchronizing device 600 is less than 0.3
μs.

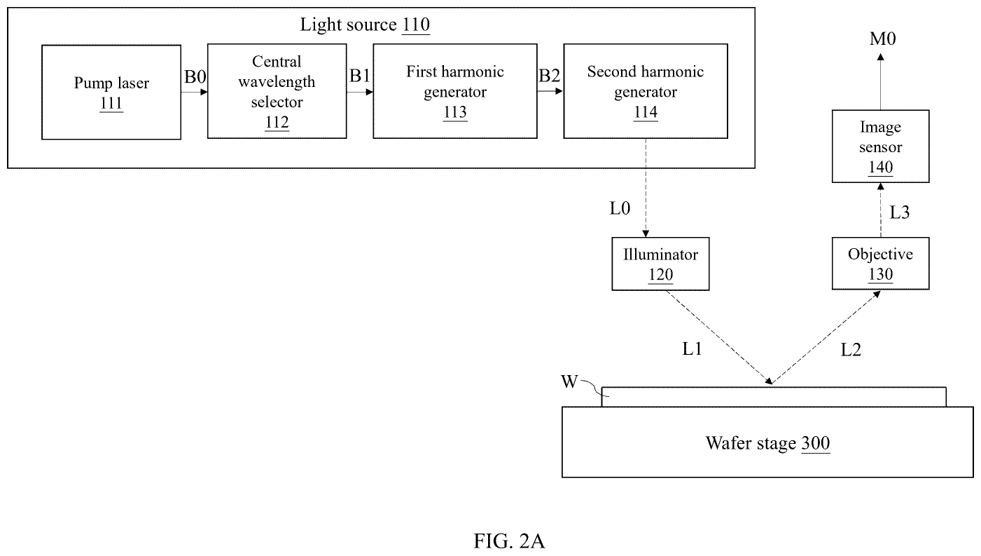

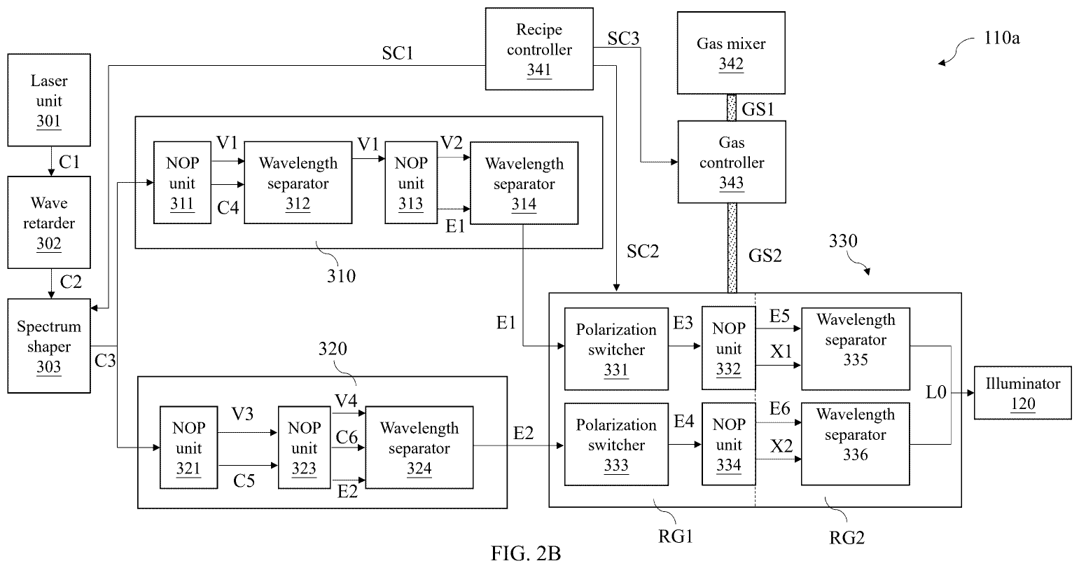

FIG. 2A is a schematic diagram of the optical device 100 according to some embodiments of the present disclosure. The inspection is performed in a bright field, so the optical device 100 is in an off-axis design fashion.

As shown in FIG. 2A, the optical device 100 includes a light source 110, an illuminator 120, an objective 130, and an image sensor 140. The light source 110 is configured to generate a laser beam L0 to the illuminator 120. The illuminator 120 is configured to transform the laser beam L0 to be the laser beam L1 and project the laser beam L1 toward the region of interest of the wafer W. The objective 130 is configured to receive and magnify an image constructed by the laser beam L2, and transmit the same to the image sensor 140. The image sensor 140 is configured to capture the image magnified by the objective 130 to generate the image M0.

In some embodiments, the laser beam L0 has a wavelength less than 120 nm. In some embodiments, the laser beam L0 is a pulsed laser beam, such as a narrow band XUV laser beam which has a wavelength ranging approximately from 50 to 120 nm. In some embodiments, the repetition rate of the laser beam L0 is about 200 Hz to about 2 MHz. In other embodiments, the laser beam L0 is a continuous wave (CW) laser beam.

In order to create a laser beam L0 having a wavelength ranging approximately from 50 to 120 nm, the light source 110 converts an infrared (IR) laser to the XUV laser by several generation steps. In order to achieve sufficient sensitivity of defect inspection, the light source 110 is configured to generate the laser beam L0 having a brightness greater than 100 W/nm/srad/mm². In addition, the point stability of the laser beam L0 is less than 1 μrad. The light source 110 is a low contamination source without debris. The light source 110 is stable and has long lifetime. In some embodiments, the sensitivities of detecting different kinds of the defects are related to the polarizations of the laser beam L0, hence, the light source 110 is configured to generate the laser beam L0 having arbitrary linear polarized direction so as to improve the overall sensitivity to all kinds of defects. In other words, the light source 110 is able to control the polarization of the laser beam L0 so as to make the laser beam L0 have the arbitrary linear polarized direction.

The light source 110 includes a pump laser 111, a central wavelength selector 112, a first harmonic generator 113, and a second harmonic generator 114.

The pump laser 111 is configured to generate a source laser beam B0 to the central wavelength selector 112. In some embodiments, the spectrum of the source laser beam B0 may start from 400 nm to 1100 nm, such as 1030 nm. The central wavelength selector 112 is configured to select wavelength ranging in the visible light or IR from the source laser beam B0 to generate a narrow band laser beam B1. In one embodiment, the central wavelength selector 112 is a band pass filter configured to block a portion of the source laser beam B0 which has the wavelength out of the pass band of the central wavelength selector 112 and allow remaining portion of the source laser beam B0 which has the wavelength within the pass band of the wavelength selector 112 to pass. In another embodiment, the central wavelength selector 112 is a Raman shifter configured to shift the spectrum of the source laser beam B0. In some embodiments, the wavelength selected by the central wavelength selector 112 is able to be adjusted. Therefore, when the central wavelength selector 112 is in use, the desired outputting wavelength (i.e., the wavelength of the laser beam L0) can be achieved. The first harmonic generator 113 is configured to convert the narrow band laser beam B1 to be a deep ultraviolet (DUV) laser beam B2. The second harmonic generator 114 is configured to convert the DUV laser beam B2 to be a XUV laser beam, i.e., the laser beam L0. In some embodiments, a wavelength of laser beam L0 is shorter than a wavelength of the DUV laser beam B2. In some embodiments, the wavelength of the laser beam L0 is less than 120 nm.

The first harmonic generator 113 and the second harmonic generator 114 apply the non-linear harmonic generation process to increase the frequency of the narrow band laser beam B1 and the DUV laser beam B2. In some embodiments, the first harmonic generator 113 converts the narrow band laser beam B1 in solid state material, namely, the first harmonic generator 113 performs a solid state non-linear process. In some embodiments, the solid state non-linear process is a second order non-linear generation. In some embodiments, the second harmonic generator 114 converts the DUV laser beam B2 in an environment of noble gas, namely, the second harmonic generator 114 performs a gas state non-linear process. In some embodiments, the gas state non-linear process is a third order non-linear generation. In other embodiments, the second harmonic generator 114 converts the DUV laser beam B2 in an environment of mixed noble gas, in which concentrations of each noble gas are controlled by a gas mixer, a pressure controller, and the host computer 700. Due to the environment of noble gas, the generation in second harmonic generator 114 is relatively clean without debris. After these two conversion stages, the wavelength of the laser beam L0 can achieve a range from about 50 nm to 120 nm. In some embodiments, the bandwidth of the laser beam L0 is less than 0.5% of the central wavelength of the laser beam L0. It should be noted that the present disclose is not limited to two stage harmonic generations. In various embodiments, more stage harmonic generations for generating the laser beam L0 are within the contemplated scope of the present disclosure. For example, a first harmonic generator 113 may include at least two non-linear harmonic generations in solid state material for converting the narrow band laser beam B1 into the DUV laser beam B2. In some embodiments, the first harmonic generator 113 may perform second-order non-linear harmonic generations, and the second harmonic generator 114 may perform third-order non-linear harmonic generations.

FIG. 2B is a schematic diagram of a light source 110a according to other embodiments of the present disclosure. In some embodiments, the light source 110a may replace the light source 100 shown in FIG. 2A. The light source 110a includes a laser unit 301, a wave retarder 302, a spectrum shaper 303, a first wavelength converting channel 310, a second wavelength converting channel 320, an XUV generator 330, a recipe controller 341, a gas mixer 342, and a gas controller 343.

The laser unit 301 is configured to generate an IR laser C1 to the spectrum shaper 303 through the wave retarder 302. The wave retarder 302 is configured to adjust the polarization of the IR laser C1 to be an IR laser C2. In some embodiments, the waver retarder 302 is configured to allow a portion of the IR lacer C1 having the corresponding polarization been transmitted to the spectrum shaper 303. The spectrum shaper 303 is configured to filter a spectrum of the IR laser C2 so as to change the spectrum of the IR laser C2, and generate an IR laser C3 accordingly. In some embodiments, the spectrum shaper 303 is the same as the central wavelength selector 112 of the light source 110. The IR laser C3 are transmitted to the first wavelength converting channel 310 and the second wavelength converting channel 320.

The first wavelength converting channel 310 includes a non-linear process (NOP) unit 311, a wavelength separator 312, a NOP unit 313, and a wavelength separator 314. The NOP unit 311 is configured to convert the IR laser C3 in a visible laser V1 and an IR laser C4, and transmit the same to the wavelength separator 312. Although the visible laser V1 and the IR laser C4 are illustrated by two separated arrows in FIG. 2B, the visible laser V1 and the IR laser C4 are actually mixed as a single light beam transmitted to the wave length separator 312. The wavelength separator 312 is configured to separate the visible laser V1 and the IR laser C4, and only transmit the visible laser V1 to the NOP unit 313. The NOP unit 313 is configured to convert the visible laser V1 to a visible laser V2 and an ultraviolet (UV) laser E1, and transmit the same to the wavelength separator 314. The wavelength separator 314 is configured to separate the visible laser V2 and the UV laser E1, and only transmit the UV laser E1 to the XUV generator 330.

The second wavelength converting channel 320 includes a NOP unit 321, a NOP unit 323, and a wavelength separator 324. The NOP unit 321 is configured to convert the IR laser C3 in a visible laser V3 and an IR laser C5, and transmit the same to the NOP unit 323. The NOP unit 323 is configured to convert the visible laser V3 and the IR laser C5 to a visible laser V4 by non-linear harmonic generation, an IR laser C6, and a UV laser E2, and transmit the same to the wavelength separator 324. The wavelength separator 324 is configured to separate the visible laser V4, the IR laser C6, and the UV laser E2, and only transmit the UV laser E2 to the XUV generator 330.

In some embodiments, the NOP unit 311, the NOP unit 313, the NOP unit 321, and the NOP unit 323 are operated in solid state material. In some embodiments, the NOP unit 311, the NOP unit 313, the NOP unit 321, and the NOP unit 323 are configured to perform second order non-linear harmonic generation to the received laser.

The number of the wavelength converting channels shown in FIG. 2B are provided for illustrative purposes, and the present disclosure is not limited thereto. In various embodiments, the light source 110a includes more than two wavelength converting channels.

The XUV generator 330 includes a polarization switcher 331, a NOP unit 332, a polarization switcher 333, a NOP unit 334, a wavelength separator 335, and a wavelength separator 336. In some embodiment, the XUV generator 330 has a high pressure region RG1 and a low XUV absorption region RG2. The polarization switcher 331, the NOP unit 332, the polarization switcher 333, and the NOP unit 334 are disposed in the high pressure region RG1, and the wavelength separator 335 and the wavelength separator 336 are disposed in the low XUV absorption region RG2. In some embodiments, the optical device 100 and the wafer W are disposed in a low XUV absorption region such as the low XUV absorption region RG2.

The polarization switcher 331 is configured to receive the UV laser E1 and rotate the polarization of the UV laser E1 so as to generate the UV laser E3 to the NOP unit 332. The NOP unit 332 is configured to convert the UV laser E3 to a UV laser E5 and an XUV laser X1 by non-linear harmonic generation. The polarization switcher 333 is configured to receive the UV laser E2 and rotate the polarization of the UV laser E2 so as to generate the UV laser E4 to the NOP unit 334. The NOP unit 334 is configured to convert the UV laser E4 to a UV laser E6 and an XUV laser X2 by non-linear harmonic generation. In some embodiments, the NOP unit 332 and the NOP unit 334 are operated in gas. In some embodiments, the NOP unit 332 and the NOP unit 334 are operated in noble gas. In some embodiments, the NOP unit 332 and the NOP unit 334 are configured to perform third order non-linear harmonic generation.

The wavelength separator 335 is configured to separate the UV laser E5 and the XUV X1, and only transmit the XUV laser X1 to the illuminator 120. Similarly, the wavelength separator 336 is configured to separate the UV laser E6 and the XUV laser X2, and only transmit the XUV laser X2 to the illuminator 120.

In some embodiments, the spectrum of the UV laser E1, the UV laser E2, the UV laser E3, the UV laser E4, the UV lase E5, and the UV laser E6 extend to the range of deep ultraviolet (DUV). In some embodiments, the central wavelength of the UV laser E1, the UV laser E2, the UV laser E3, the UV laser E4, the UV lase E5, and the UV laser E6 is within the range of DUV. In some embodiments, the central wavelength of the UV laser E1, the UV laser E2, the UV laser E3, the UV laser E4, the UV lase E5, and the UV laser E6 are in the range between about 200 nm to about 280 nm.

The UV laser E1 and the UV laser E2 are different, and the XUV laser X1 and the XUV laser X2 are different. Specifically, a spectrum and central wavelength of the UV laser E1 is different from a spectrum and central wavelength of the UV laser E2, and a spectrum and central wavelength of the XUV laser X1 is different from a spectrum and central wavelength of the XUV laser X2. The first wavelength converting channel 310 and the second wavelength converting channel 320 are operated separately. Alternatively stated, when the first wavelength converting channel 310 is enable, the second wavelength converting channel 320 is disable, and vice versa. When the first wavelength converting channel 310 is disable, the polarization switcher 331, the NOP unit 332, and the wavelength separator 335 are disable. When the second wavelength converting channel 320 is disable, the polarization switcher 333, the NOP unit 334, and the wavelength separator 336 are disable. Accordingly, the XUV generator 330 is configured to generate the XUV laser X1 or the XUV laser X2 as the incident laser beam L0

In some conventional arts, when the object under inspect is changed, the inspection light may be changed accordingly to adapt to the features of the new object under inspect. In this situation, the light source has to be changed because the conventional light source is only able to emit the light beam having fixed spectrum and fixed central wavelength. Compared to the light source 110a of present disclosure, the light source 100a is able to generate more than one kind of incident laser beam L0 (i.e., the XUV laser X1 and the XUV laser X2). Therefore, when the light source 110a is applied, the light source 100a is able to generate the incident lights L0 of different spectrums to different wafer W without changing the light source 100a.

The recipe controller 341 is configured to generate a control signal SC1, a control signal SC2, and a control signal SC3 according a predetermined recipe. In some embodiments, the predetermined recipe is provided by the host computer 700. The control signal SC1 is transmitted to the spectrum shaper 303, and the spectrum shaper 303 is configured to select a desired wavelength according to the control signal SC1.

The control signal SC2 is transmitted to the XUV generator 330, and the XUV generator 330 is operated according to the SC2. In some embodiments, the polarization switcher 331 and the polarization switcher 333 select a desired polarization according to the control signal SC2.

The gas mixer 342 is configured provided a source gas GS1 to the gas controller 341. In some embodiments, the source gas SG1 includes single material, such argon or neon. In other embodiments, the source gas SG1 includes several materials, such as mixed noble gas. The gas controller 343 is configured to purge the source gas GS1 into the high pressure region RG1 of the XUV generator 330 according to the control signal SC3 so as to maintain the pressure of the high pressure region RG1 at a desired level. Since the source gas GS1 is purged, the pressure of the source gas GS1 may change. When the pressure of the source gas SG1 is changed, the gas is designated with the reference numeral GS2.

In some embodiments, in response to different materials of the wafers W, the light source 100 is able to change the central wavelength of the incident laser beam L0 by controlling the gas for non-linear harmonic generation performed by the second harmonic generator 114 and/or the wavelength selected by central wavelength selector 112. Similarly, the light source 110a is able to change the central wavelength of the incident laser beam L0 by controlling the gas GS2 and/or the channels been activated.

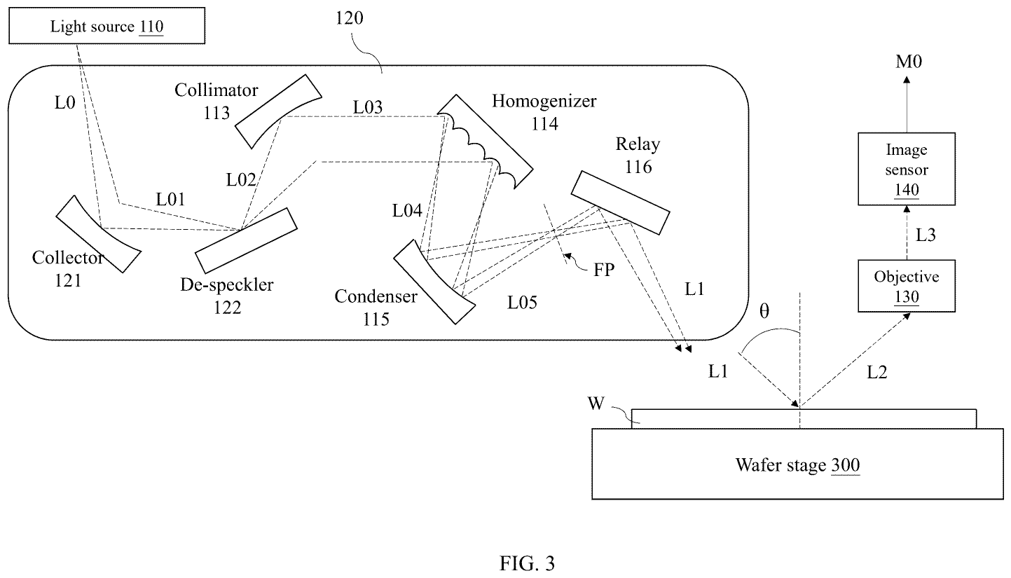

FIG. 3 is a schematic diagram of the optical device 100 according to some embodiments of the present disclosure. The illuminator 120 is configured to collect the laser beam L0 from the light source 110 (or the light source 100a) and transform the laser beam L0 to be the laser beam L1. In some embodiment, the illuminator 120 guides the laser beam L1 to the wafer W in an angle θ ranging from 20 to 45 degrees. A numerical aperture (NA) of the illuminator 120 corresponds to an illumination area on the wafer W and a field of view (FOV) of the image sensor 140. In some embodiments, the NA of the illuminator 120 and the objective 130 is ranging from 0.2 to 0.5. In some embodiments, the NA of the illuminator 120 and the objective 130 is 0.3. In the embodiment, the illuminator 120 is a catoptric system, which means elements in the system can be reflective optics.

The illuminator 120 includes a collector 121, a de-speckler 122, a collimator 113, a homogenizer 114, a condenser 115, and a relay 116. It should be noted that most of the optical elements are opaque to the XUV, therefore, the optical device 100 of the present disclosure is a catoptrics device. The dash lines shown in FIG. 3 indicate the laser beam L0 reflected in each elements within the illuminator 120. However, the dash lines shown in FIG. 3 are provided for illustrated purposes, the present disclosure is not limited thereto. In various embodiments, the light beam in the illuminator 120 can have different shapes or directions depending on the arrangements of the illuminator 120.

The collector 121 is configured to collect and project the laser beam L0 onto the de-speckler 122. The collector 121 control a spot size of the light beam L0 and transform the laser beam L0 to be a laser beam L01 projected on the de-speckler 122, so as to control an etendue of the illuminator 120.

The laser beam L0 and the laser beam L01 are coherent light. In some embodiments, coherent light may cause strong speckle which may severely affect the detect result RD. In order to mitigate the effect caused by the speckle, the de-speckler 122 is configured to decrease a degree of coherence of the laser beam L01. In some embodiments, the laser beam L0 and laser beam L01 are Gaussian beam with a NA about 0.004. The de-speckler 122 scatters and reflects the laser beam L01 to be a laser beam L02 with a NA ranging from 0.015 to 0.025. In other words, the degree of coherence of the laser beam L02 is lower than the degree of coherence of the laser beam L0 or L01.

The collimator 113 is configured to collimate the laser beam L02 to be a collimated laser beam L03, and transmit the collimated laser beam L03 to the homogenizer 114.

The homogenizer 114 is configured to unify the light intensity of the collimated laser beam L03 and shape the collimated laser beam L03 to be a laser beam L04. The condenser 115 is configured to condense the laser beam L04 to be a laser beam L05, and the laser beam L05 converges on an intermediate focal plan FP.

The relay 116 is configure to adjust the NA and relay the laser beam L05 to be the laser beam L1 so as to match the imaging FOV of the image sensor 140. The laser beam L1 is transmitted with the NA ranging from 0.2 to 0.5. In some embodiments, the laser beam L1 is transmitted with the NA about 0.3.

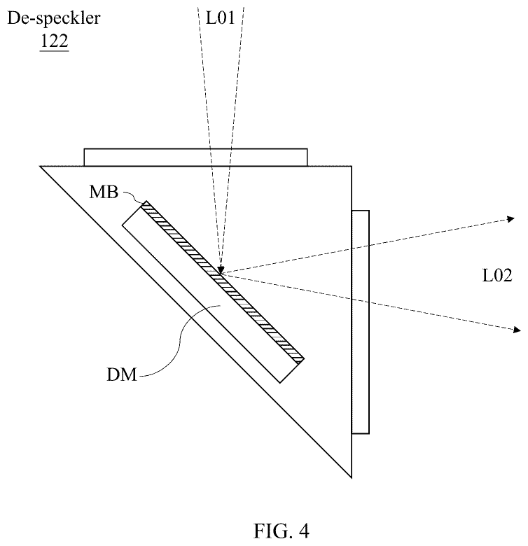

FIG. 4 is a schematic diagram of the de-speckler 122 according to some embodiments of the present disclosure. The de-speckler 122 includes a deformable mirror DM. The deformable mirror DM includes a membrane MB which can have random vibration thereon varying along with time. Because of the random vibration, the membrane MB is presented with random ripple, and as the laser beam L01 encounters the random scattered conditions on the membrane MB, the phase of the laser beam L01 is abrupt. Thus, the degree of coherence of the laser beam L01 is decreased after scattered by the de-speckler 122.

Furthermore, the de-speckler 122 is configured to adjust the spot size of the laser beam L01. Particularly, no matter what the dimension of the spot size of the laser beam L01 on the deformable mirror DM, the dimension of the spot size of the laser beam L02 is substantially the same.

In other embodiments, the deformable mirror DM does not include the membrane MB but a piezoelectric component (not shown). A control voltage is applied to the piezoelectric component, and the piezoelectric element is able to provide a shear stress to cause the deformable mirror DM having high speed vibration. Therefore, the laser beam L01 encounters the random scattered condition due to the high speed vibration and the degree of coherence of the laser beam L01 is decreased.

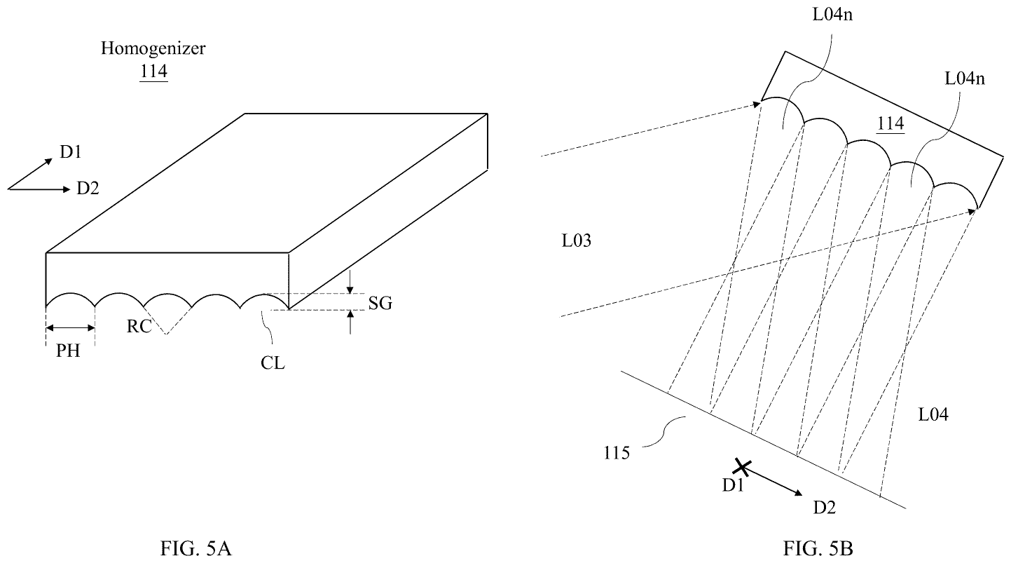

FIG. 5A is a schematic diagram of the homogenizer 114 according to some embodiments of the present disclosure. The homogenizer 114 is implemented by cylindrical concave mirror array. As illustrated in FIG. 5A, the homogenizer 114 includes cylindrical mirrors CL each extending along a longitudinal direction D1 and arranged along a latitudinal direction D2. Each cylindrical mirror CL has a concave surface for receiving the collimated laser beam L03. In some embodiments, the cylindrical mirrors CL are identical. In other words, a pitch PH, a sag SG, and a radius of curvature RC of each cylindrical mirrors CL are the same. In some embodiments, the peak value of the surface irregularity of the cylindrical mirror CL is less than 150 nm.

FIG. 5B is a schematic diagram of laser transmission between the homogenizer 114 and the condenser 115 according to some embodiments of the present disclosure. In some embodiments, the image sensor 140 is a time delay integration (TDI) sensor, so a sensing area (or FOV) of the image sensor 140 is rectangular. In such case, if the image sensor 140 receives a laser beam having an intensity profile evenly distributing in a rectangle or along a primary dimension of the rectangle, the image sensor 140 may have optimal performance. However, the intensity profiles of the laser beam L0, laser beam L01, the laser beam L02, and the collimated laser beam L03 are distributed concentrically. Therefore, the homogenizer 114 is utilized to transform the intensity profile of the collimated laser beam L03 from a concentric circle to a rectangle.

Specifically, each cylindrical mirror CL scatters the collimated laser beam L03 to be a beam portion L04n, and the beam portions L04n are substantially identical. Because the cylindrical mirrors CL are arranged along the latitudinal direction D2, the beam portions L04n are also arranged along the latitudinal direction D2 without overlapping to form the laser beam L04. Therefore, the laser beam L04 can have the intensity profile close to a rectangle.

It should be noted that the number of cylindrical mirrors CL (such as 5 cylindrical mirrors CL shown in FIG. 5A and FIG. 5B) is for illustrative purposes. The present disclosure is not limited there to. In various embodiments, the homogenizer 114 includes more cylindrical mirrors CL.

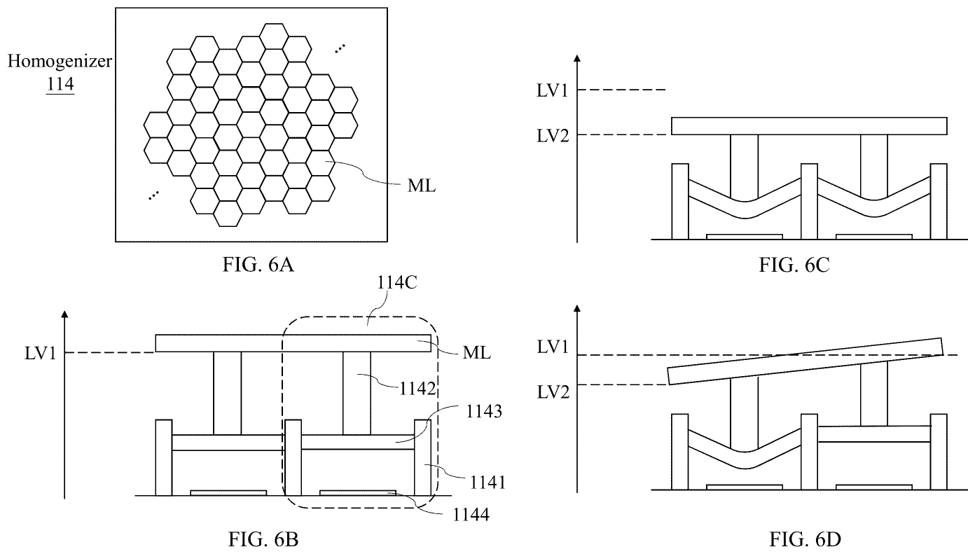

FIG. 6A is a schematic diagram of the homogenizer 114 according to other embodiments of the present disclosure. The homogenizer 114 may be implemented by micro electro mechanical system (MEMS) mirrors ML. The MEMS mirrors ML are arranged in a 2-dimentional array. In some embodiments, each MEMS mirrors ML is a hexagon from a top view. The MEMS mirrors ML can be controlled to have different positions and tilted angles so as to form a random ripple surface on the homogenizer 114.

FIG. 6B is a cross-sectional diagram of the homogenizer 114 according to other embodiment of the present disclosure. The homogenizer 114 includes a plurality of control units 114C. The control units 114C is configured to control the position and the tilted angle of the MEMS mirror ML.

The control unit 114C includes a frame 1141, a connector 1142, a deformable element 1143, an electrode 1144, and the MEMS mirror ML. The electrode 1144 is disposed on a bottom of the frame 1141. The deformable element 1143 is disposed in the frame 1141 and connected with the MEMS mirror ML through the connector 1142.

In some embodiments, when a control voltage is applied on the electrode 1144, the deformable element 1143 is deformed in response to an electric filed generated by the electrode 1144. When a central portion of the deformable element 1143 is deformed and bended toward the electrode 1144, the connector 1142 pulls down the MEMS mirror ML from a level LV1 to a level LV2 as illustrated in FIG. 6C.

In some embodiments, when the central portion of the deformable element 1143 of one control unit 114C is deformed and bended toward the electrode 1144 while the deformable element 1143 of an adjacent control unit 114C is not deformed, a portion of the MEMEs mirror ML is lowered to the level LV2 and another portion of the MEMEs mirror ML is still remained at the level LV1. In such case, the MEMS mirror ML is tilted as illustrated in FIG. 6D.

In some embodiments, a maximum offset between the level LV1 and the level LV2 is about 3.5 μm. In some embodiments, a maximum tilted angle of the MEMS mirror ML is about 8 mrad.

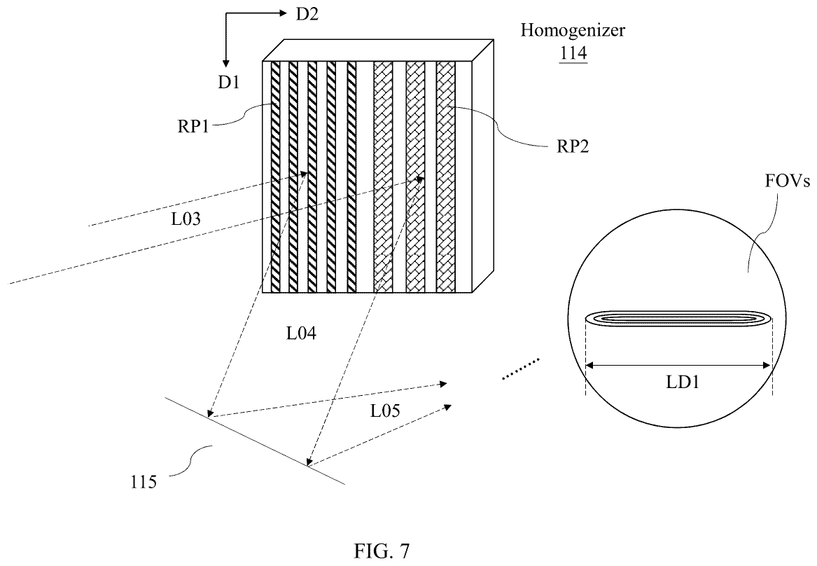

FIG. 7 is a schematic diagram of the homogenizer 114 according to various embodiments of the present disclosure. The homogenizer 114 includes a plurality of first ripple structures RP1 and a plurality of second ripple structure RP2. Each of the first ripple structures RP1 and the second ripple structures RP2 are extended along the longitudinal direction D1 and arranged along the latitudinal direction D2. The first ripple structure RP1 is different from the second ripple structure RP2. Specifically, a radius of curvature of the first ripple structure RP1 is different from a radius of curvature of the second ripple structure RP2.

In some embodiments, when the collimated laser beam L03 is projected on the homogenizer 114, the homogenizer 114 is bouncing back and forth along the latitudinal direction D2. By doing this way, the homogenizer 114 can transform the laser beam L03 from a concentric circle to a rectangle and unify the intensity profile among the rectangle.

In some embodiments, the radius of curvature and the pitch of the ripple structure are associated with a longitudinal dimension LD1 of the beam shape on the FOVs of the image sensor 140. For example, the greater radius of curvature is applied, the shorter longitudinal dimension LD1 is obtained. For example, when the radius of curvature is equal to 4, 8, 16, and 32 mm, the longitudinal dimension LD1 is about 830, 410, 180, and 80 μm, respectively. In some embodiments, the homogenizer 114 is movable along the latitudinal direction D2, so as to allow the collimated laser beam L03 to be irradiated on the first ripple structures RP1 or the second ripple structures RP2, thereby adjusting the longitudinal dimension LD1 of the beam shape accordingly. In some embodiments, the homogenizer 114 may use both the first ripple structure RP1 and the second ripple structure RP2 to reflect the collimated laser beam B03.

In some embodiments, the homogenizer 114 does not change the beam size of the collimated laser beam L03. In some embodiments, the NA of the collimated laser beam L03 is substantially equal to the NA of the laser beam L04.

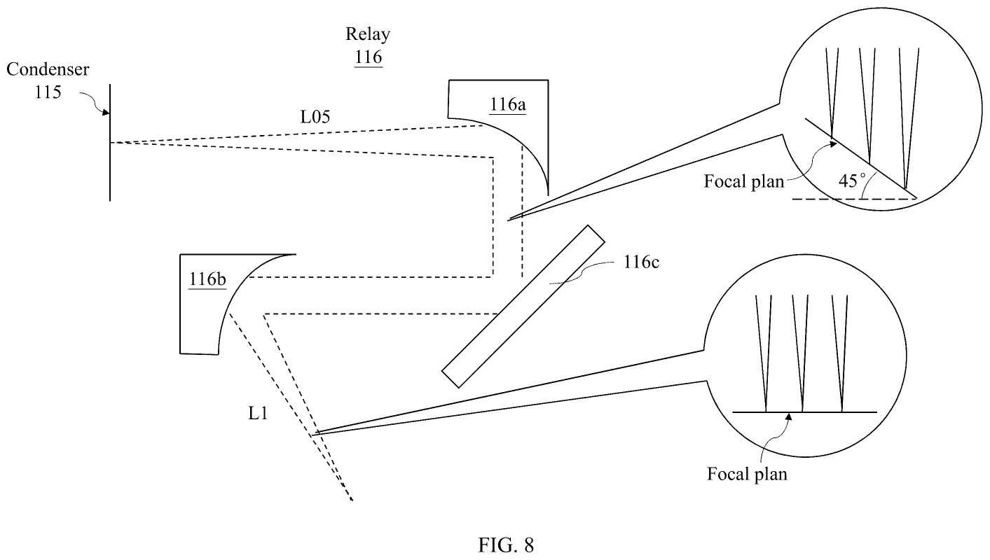

FIG. 8 is a schematic diagram of the relay 116 according to some embodiments of the present disclosure. The relay 116 is configured to control a tilted angle of a focal plan and the dimension of the illumination field of the laser beam L1.

The relay 116 includes a first relay element 116a, a second relay element 116b, and a folding mirror 116c. The relay 116 guides the laser beam L05 through the first relay element 116a, the folding mirror 116c, and the second relay element 116b to be the laser beam L1.

The first relay element 116a and the second relay element 116b are aspherical mirrors. In some embodiments, the first element 116a and the second relay element 116b are off-axis parabolic (OAP) mirrors. By utilizing the aspherical mirrors, the aberration can be reduced.

Since the radius of curvature of the relay element is associated with the tilted angle of the focal plan, the radius of curvature of the first relay element 116a and the second relay element 116b can be designed to obtain the desired tilted angle. For example, in some embodiments, after the laser beam L05 reflected by the first relay element 116a, a tilted angle of a focal plane is about 45 degree. When a ratio between the radius of curvature of the first relay element 116a and the radius of curvature of the second relay element 116b is equal to 2:1, a tilted angle of the focal plan of the laser beam L1 reflected by the second relay element 116b can be adjusted to about 0 degree.

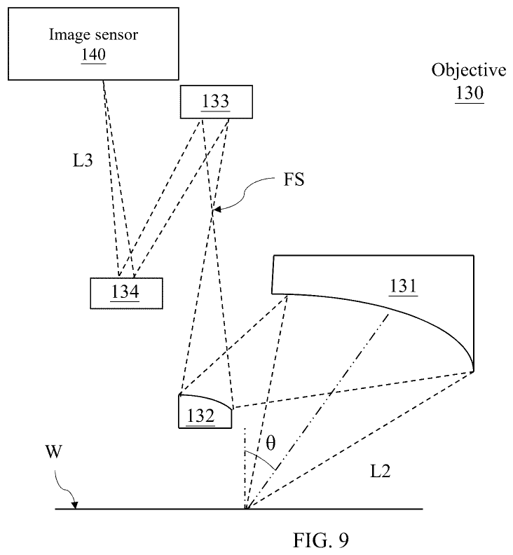

FIG. 9 is a schematic diagram of the objective 130 according to some embodiments of the present disclosure. The objective 130 is configured to magnify the image constructed by the laser beam L2. Specifically, the objective 130 is configured to provide a magnification ranging from 100 to 600 to the image constructed by the laser beam L2. The objective 130 includes two stages. The first stage includes a mirror 131 and a mirror 132, and the second stage includes a mirror 133 and a mirror 134.

In some embodiments, the first stage provides a magnification ranging from 20 to 80, and the second stage provide a magnification ranging from 5 to 25. In some embodiments, the magnifications provided by the first stage and the second stage are constant. In other embodiments, the magnification provided by the first stage or the second stage is constant, and the other one is adjustable.

The mirror 131 and the mirror 132 are part of Schwarzschild objective. Specifically, the mirror 131 corresponds to the concave mirror of Schwarzschild objective, and the mirror 132 corresponds to the convex mirror of the Schwarzschild objective. The mirror 131 and the mirror 132 are cropped from the concave mirror and the convex mirror of the Schwarzschild objective according to the chief ray angle (CRA) of the laser beam L2. For example, when a beam having a CRA equal to 20 to 45 degree, only some portion of the concave mirror of the Schwarzschild objective is illuminated by the beam, and such illuminated portion of the concave mirror can be cropped as the mirror 131.

As mentioned above, the laser beam L1 is guided with the angle θ toward the wafer W, and thus, the laser beam L2 is reflected toward the objective 130 with the same angle θ accordingly. In such case, the CRA of the laser beam L2 is equal to the angle θ.

In some embodiments, the mirror 131 and the mirror 132 are aspherical mirrors while the mirror 133 and mirror 134 are spherical mirrors or flat mirrors. In other embodiments, the mirror 133 and the mirror 134 are aspherical mirrors.

As illustrated in FIG. 9, an intermediate focus FS is presented between the mirror 132 and the mirror 133, and the mirror 133 and the mirror 134 can be aligned according to the intermediate focus FS.

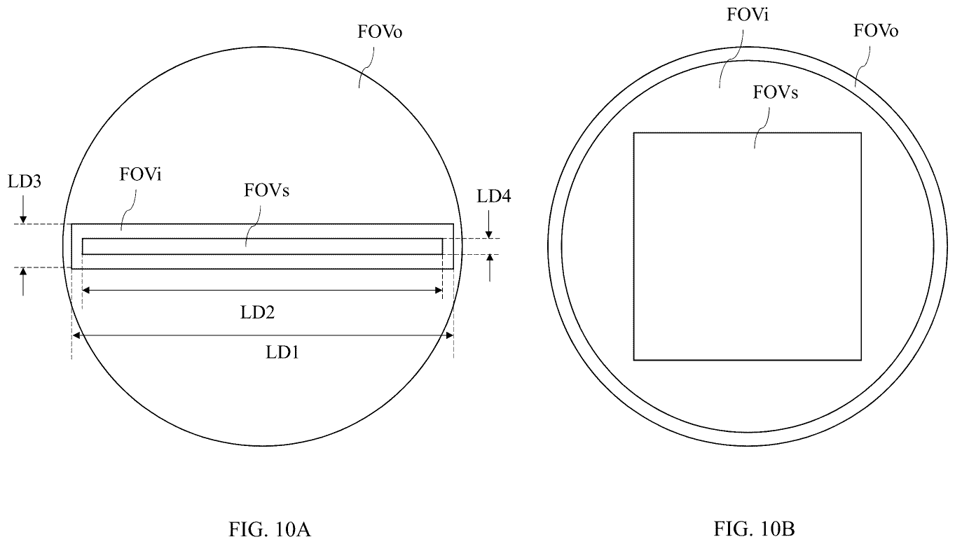

FIG. 10A and FIG. 10B are schematic diagrams of the field of views of the illuminator 120, the objective 130, and the image sensor 140 according to some embodiments of the present disclosure.

In the embodiments shown in FIG. 10A, the image sensor 140 is implemented by a line sensor of a TDI sensor, and the field of view FOVs on the wafer W is rectangle. Thus, the field of view FOVi of the illuminator 120 is designed to be rectangle and able to cover the entirety of the field of view FOVs of the image sensor 140. In addition, the field of view FOVo of the objective 130 should cover the entirety of field of view FOVi of the illuminator 120.

In some embodiments, the longitudinal dimension LD1 of the field of view FOVi of the illuminator 120 is about 100 μm, and a longitudinal dimension LD2 of the field of view FOVs of the image sensor 140 is about 98 μm. In some embodiments, a latitudinal dimension LD3 of the field of view FOVi of the illuminator 120 is about 6 μm, and a latitudinal dimension LD4 of the field of view FOVs of the image sensor 140 is about 2.56 μm. The field of view FOVo of the objective 130 is circle and has a dimeter greater than 100 μm.

In the embodiments shown in FIG. 10B, the image sensor 140 is implemented by an area sensor, and the field of view FOVs of the sensor 140 on the wafer W is square. Thus, the field of view FOVi of the illuminator 120 is designed to be square and able to cover the entirety of the field of view FOVs of the sensor 140. In addition, the field of view FOVo of the objective 130 should cover the entirety of field of view FOVi of the illuminator 120.

In some embodiments, the diagonal of the field of view FOVs of the sensor 140 is about 100 μm. A diameter of the field of view FOVi of the illuminator 120 is greater the diagonal of the field of view FOVs of the image sensor 140, and dimeter of the field of view FOVo of the objective 130 is greater than the diameter of the field of view FOVi of the illuminator 120.

In some embodiments, an optical resolution of the optical inspection system 10 is equal to 0.5*λ/NA, in which NA is the numerical aperture of the illuminator 120 and the objective 130, and λ is the wavelength of the laser beam L1. A pixel resolution of the image sensor 140 is at least two times smaller than the optical resolution of the optical inspection system 10. In some embodiments, the pixel resolution of the image sensor 140 is seven times smaller than the optical resolution of the optical inspection system 10.

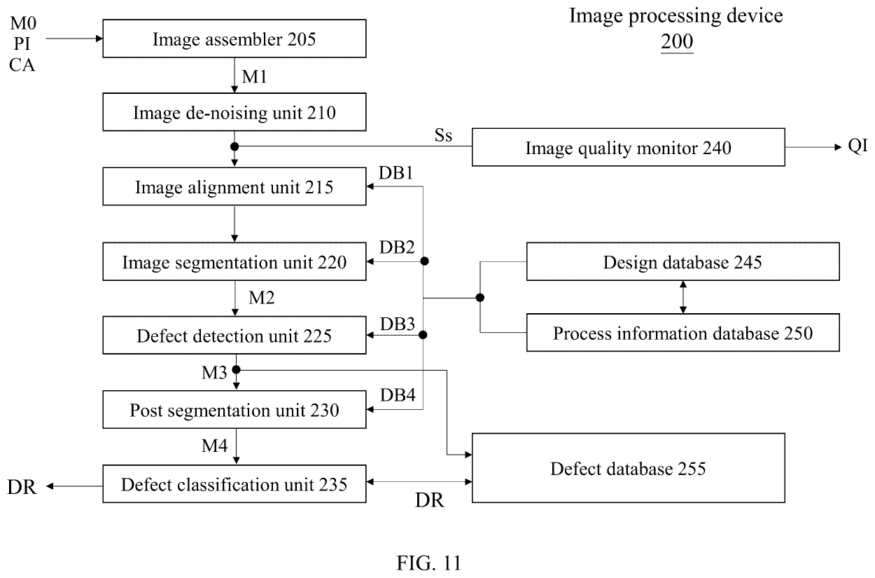

In some embodiments, after the image sensor 140 captures the images of the wafer W, the image processing device 200 performs the defect detection and classification according to the captured images so as to provide the detection result DR of the wafer W. In some embodiments, the image processing device 200 can be a cluster of high performance computing (HPC) servers that support machine learning models for the defect detection and classification with high throughput. FIG. 11 is schematic diagram of the image processing device 200 according to some embodiments of the present disclosure. The image processing device 200 includes an image assembler 205, an image de-noising unit 210, an image alignment unit 215, an image segmentation unit 220, a defect detection unit 225, a post segmentation unit 230, a defect classification unit 235, an image quality monitor 240, a design database 245, a process information database 250, and a defect database 255.

The image assembler 205 is configured to receive the image M0, the position P1, and the calibration algorithm CA. In some embodiments, each image M0 can be viewed as a small segment of the wafer W, and the image assembler 205 performs the calibration algorithm CA to assemble, according to the position P1, these segments into an image M1 with a predefined format for further processing. In some embodiments, the assemble operation includes concatenation, overlapping, and adding heading.

The image de-noising unit 210 is configured to perform a de-noising algorithm to decrease the noise in the image M1 so as to increase the detection accuracy. In some embodiments, the image de-noising unit 210 may support a plurality of de-noising algorithms, and at least one specific de-noising algorithm may be adopted according to the selection of the detection algorithm.

The image alignment unit 215 is configured to perform one of alignment algorithms to align the pixel and subpixel of the image sensor 140. In some embodiments, the image alignment unit 215 is further configured to receive a selecting signal Ss from the image quality monitor 240, in which the selecting signal Ss is configured to indicate which alignment algorithm should be used. In other words, the image quality monitor 240 is configured to decide a proper alignment algorithm for the image alignment unit 215 to perform the instant alignment. In some embodiments, the design database 245 may also provide information DB1 for the image alignment unit 215 so as to improve the performance of the pixel and subpixel alignment.

In some embodiments, the alignment of the pixel of the image sensor 140 is performed first to ensure the alignment resolution around a dimension of one pixel, and the alignment of the subpixel of the image sensor 140 is then performed to improve the alignment resolution being less than the dimension of one pixel. After the alignment of subpixel of the image sensor 140, the alignment resolution may be about 0.5, 0.1, or 0.01 times of the dimension of one pixel. In some embodiments, the defect and the circuit pattern are both less than the dimension of one pixel, therefore, the alignment resolution should be at least less than the dimension of one pixel, otherwise, the defect cannot be distinguished from the circuit pattern.

In some embodiments, the information DB1 provides a die-to-die (D2D) algorithm for the image alignment unit 215 to improve the performance of the pixel and subpixel alignment. In some embodiments, the D2D algorithm enables the image alignment unit 215 to align the similar areas (such as the dies having the same pattern) with each other.

In some embodiments, the information DB1 provides a die-to-database (D2DB) algorithm for the image alignment unit 215 to improve the performance of the pixel and subpixel alignment. In some embodiments, the D2DB algorithm enables the image alignment unit 215 to align the image with a golden image (i.e., a desired image without defect).

The image segmentation unit 220 is configured to perform a first segmentation algorithm to divide the image M1 into several segments M2. In some embodiments, the first segmentation algorithm includes smoothing and augmentation to decrease the noise level. The first segmentation algorithm is performed to isolate or highlight potential defect regions from the background or normal areas of the wafer image. That is, put similar images (such as the images of the regions having similar pattern) into the same group in order to improve computing speed and accuracy. In such case, the images of suspicious/defective regions may be separated from the rest of the images which may be free of defects. Hence, the following defect detection is easier to identify and analyze the defect from the images which are gone through the first segmentation algorithm. Therefore, the image segmentation unit 220 divides the image M1 into several segments M2 so that each segment M2 can be inspected using different algorithms. In some embodiments, the design database 245 may also provide information DB2 for the image segmentation unit 220 so as to improve the performance of image segmentation.

The defect detection unit 225 is configured to detect whether a defect or which type of defect existed in each segments M2, and generate initial results M3 corresponding the segments M2, respectively. The defect detection unit 225 is configured to receive an information DB3 from the design database 245. In some embodiments, the information DB3 include a D2D algorithm, a die to cell (D2C) algorithm, or a die to AI (D2AI) algorithm. The D2D, D2C, or D2AI algorithm provides functions of pattern searching, pattern explorer, pattern centric yield manager, and/or pattern centric machine learning, and the defect detection unit 225 applies the D2D, D2C, or D2AI algorithm to detect and determine the defects.

The post segmentation unit 230 receives an information DB4 from the design database 245, in which the information DB4 includes a second segmentation algorithm. The post segmentation unit 230 is configured to perform the second segmentation algorithm to divide each initial result M3 into segments M4. The post segmentation unit 230 divides the initial results M3 according to the kinds of defects. In some embodiments, the post segmentation unit 230 is further configured to check whether the defect detected by the defect detection unit 225 is existed. In other words, the post segmentation unit 230 is able to perform false defect filtering.

The defect classification unit 235 is configured to perform a classification algorithm to classify the defects in the segments M4 into different categories, and generate the detection result DR accordingly. In some embodiments, the defect classification unit 235 classifies the defects according to shape, dimension, and/or area of the defect.

In some embodiments, the aforementioned algorithms (the de-noising algorithm, the alignment algorithm, the first segmentation algorithm, the second segmentation algorithm, the D2D algorithm, the D2C algorithm, and the D2AI algorithm) are classic algorithms, machine learning (ML) algorithms, or the combinations thereof.

The image quality monitor 240 is configured to monitor the quality of image M1. In some embodiments, the image quality monitor 240 monitor the alignment between captured image and reference die, the alignment between captured image and database (i.e., golden images), defocus/focus, illumination intensity homogeneity, aberration of objective, and/or other calibration item of the image M1, and feed the quality information QI back to the host computer 700.

In some embodiments, the data in the design database 245 is built in the GDSII format or the Oasis format. The design database 245 is configured to provide support to automatic recipe generation by combining the process information database 250 and the wafer's information. In some embodiments, the design database 245 is configured to help to determine the polarization of the laser beam L1 according to the type of defect, since the defect may be sensitive to the laser beam L1 having certain polarization. In some embodiments, the design database 245 is configured to provide collective pupil configurations according to the type of defect, so that the image diffraction can be decreased.

The process information database 250 is configured to collect and build process related data for the inspection. In some embodiments, the process related data includes technology nodes, process steps, equipment, materials, and optical characteristic of the optical device 100. The process information database 250 is further configured to provide required parameters when the de-noising algorithm, alignment algorithm, first segmentation algorithm, second segmentation algorithm, D2D algorithm, D2DB algorithm, D2C algorithm, and D2AI algorithm are performed, and the required parameters are transmitted along with the information DB1-DB4 to the corresponded units. In some embodiments, the process information database 250 is further configured to transmit automatic inspection condition settings to the host computer 700, such as setting of the wavelength, apertures, and polarization.

The defect database 255 is configured to store the defect information, such as the detection result DR. The defect database 255 is able to provide the stored information for data analysis and incremental machine learning model tuning.

In some embodiments, the design database 245, the process information database 250, and the defect database 255 provide application programming interfaces (APIs) for retrieval, search, and summarization at any aggregation level (for example, the layer, die, wafer, or lot level).

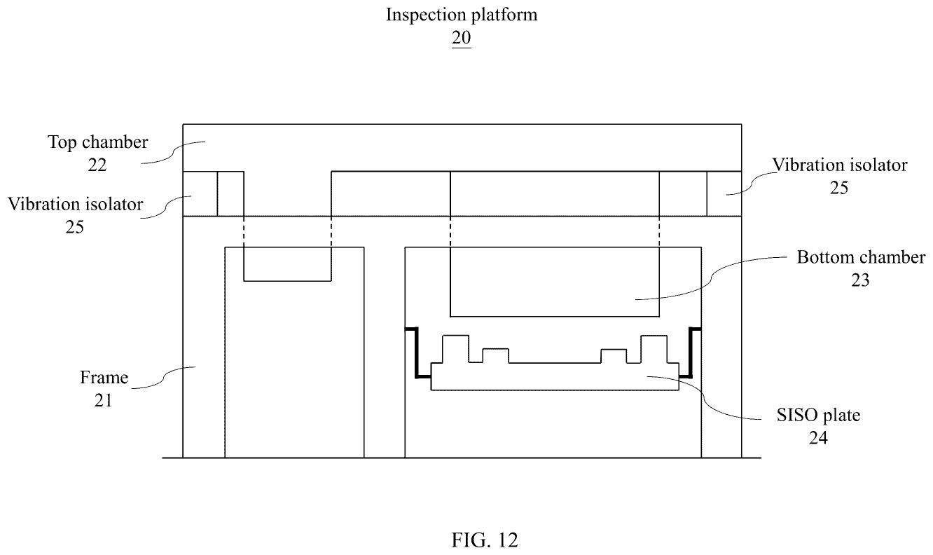

FIG. 12 is a schematic diagram of an inspection platform 20 according to some embodiments of the present disclosure. In some embodiments, the optical inspection system 10 is implemented in the inspection platform 20.

The operation of the optical inspection system 10 includes an initial phase and an operation phase. In the initial phase, the inspection platform 20 cooperates with the host computer 700 to calibrate the stage coordinate system and the image coordinate system. In the operation phase, the inspection platform 20 cooperates with the synchronizing device 600 and the host computer 700 to synchronize the movement of the wafer W, the timing of generating the laser beam L1, and the timing of capturing the laser beam L2.

The inspection platform 20 includes a frame 21, a top chamber 22, a bottom chamber 23, a shift-in shift-out (SISO) plate 24, and a vibration isolator 25. The top chamber 22 is housed on the frame 21 via the vibration isolator 25. The SISO plate 24 is installed in a lower portion of the frame 21. The bottom chamber 23 can be assembled with the top chamber 22. As illustrated in FIG. 12, the entirety of the top chamber 22 and the bottom chamber 23 are lifted by the vibration isolator 25. The vibration isolator 25 is configured to alleviate the vibration propagated from the external environment through the frame 21.

In some embodiments, the optical device 100, the optical microscope OM, and the Z sensor (height sensor) ZS are mounted on the top chamber 22, and the wafer stage 300 for carrying the wafer W is disposed in the bottom chamber 23. In some embodiments, the spatial position measurement SPM is mounter on the frame 21 or the bottom chamber 23. The top chamber 22 and the bottom chamber 23 enclose a space for wafer inspection. In one embodiment, the spatial position measurement SPM includes interferometer.

The operation of the optical inspection system 10 further includes a service phase. In the service phase, the bottom chamber 23 is de-assembled with the top chamber 22, and the SISO plate 24 is configured to shift out the bottom chamber 24 from the inspection platform 20. Because the top chamber 22 and the bottom chamber 23 can be de-assembled with each other, the maintenance to the bottom chamber 23 and the other part of the inspection platform 20 is easy to be performed.

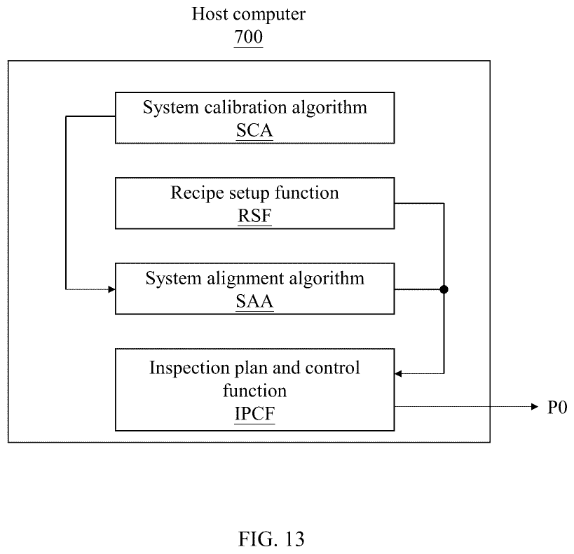

FIG. 13 is a schematic diagram of the host computer 700 according to some embodiments of the present disclosure.

The optical inspection system 10 uses the stage coordinate system and the image coordinate system, in which the movement of the wafer W is defined by the stage coordinate system, and the movement of the image (such as the image M0) is defined by the image coordinate system. In the initial phase, the host computer 700 perform a system calibration algorithm SCA to build a transformation between the stage coordinate system and the image coordinate system. After the transformation is built, when a position or a movement in the stage coordinate system is obtained, a corresponded position or a corresponded movement in the image coordinate system can be known by performing to the transformation. The host computer 700 also performs the system calibration algorithm SCA to match the region of interest on the wafer W with the focal point of the laser beam L1.

The host computer 700 is configured to perform a recipe setup function RSF to receive instructions externally. In some embodiments, a user is able to set a recipe to the optical inspection system 10 through the recipe setup function RSF. In some embodiments, the user is able to see the wafer W through the optical microscope OM and decide regions of the wafer W to be inspected, and the user is able to inform the host computer 700 through the recipe setup function RSF to make these regions being included in the predetermined inspection path P0.

In addition, the host computer 700 is configured to perform a system alignment algorithm SAA to correct the position the wafer W so as to compensate an offset accumulated through a wafer loading process.

The host computer 700 is further configured to perform an inspection plan and control function IPCF to determine the predetermined inspection path P0. Specifically, the host computer 700 receives the data input via the recipe setup function RS, obtains the alignment result by performing the system alignment algorithm SAA, and determines the predetermined inspection path P0 accordingly. The predetermined inspection path P0 is then sent to the image processing device 200, the motion controlling device 400, and the synchronizing device 600.

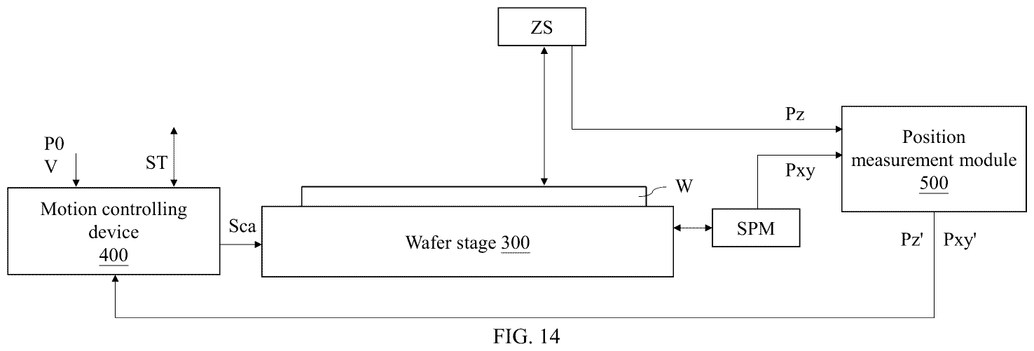

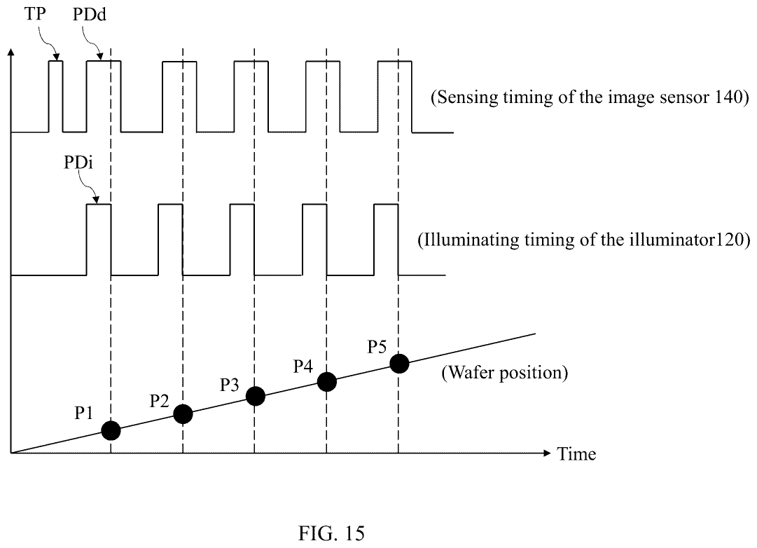

FIG. 14 is a schematic diagram of motion controlling during the operation phase according to some embodiments of the present disclosure. The motion controlling device 400 is configured to generate target points based on the predetermined inspection path P0 and the moving speed V. The target points represents the positions in the region of interest of the wafer W. At the beginning of the operation phase, the synchronizing device 600 sends a trigger signal ST to the motion controlling device 400 so as to inform the motion controlling device 400 starting move the wafer W along the predetermined inspection path P0. In some embodiments, the trigger signal ST can be generated by the motion controlling device 400. In such embodiment, the motion controlling device 400 starts the operation phase and inform the synchronizing device 600 by the trigger signal ST.

When the wafer W is moving, the spatial position measurement SPM and the Z sensor ZS are continuously sense the position Pxy and the position Pz, respectively. In some embodiments, the position Pxy and the position Pz may include error due to some non-ideal factors. The position measurement module 500 is configured to perform a compensation algorithm to correct the position Pxy and the position Pz. A corrected position Pxy′ and a corrected position Pz′ are transmitted to the motion controlling device 400. It should be noted that the corrected position Pxy′ and the corrected position Pz′ are real-time position of the wafer W, and the motion controlling device 400 can compare the real-time positions and the target points (i.e., the positions on the predetermined inspection path P0) so as to adjust the motion of the wafer W. For example, when an offset between the real-time position and the target point exceeds a threshold, the motion controlling device 400 performs a control algorithm to generate a calibrating signal Sca to the wafer stage 300. Then, the wafer stage 300 generates a force to change a position, a speed, and/or an acceleration of the wafer W in response to the calibrating signal Sca, so as to keep the offset less than the threshold.

FIG. 15 is a schematic diagram of the synchronization of illumination, image sensing, and wafer's position according to some embodiments of the present disclosure. The synchronizing device 600 is configured to control the timing of illumination and sensing according to the position of the wafer W, so that the movement of the region of interest (denoted by P1-P5) of the wafer W can be synchronized with the illumination period PDi of the laser beam L1 and the detection period PDd of the image sensor 140.

As shown in FIG. 15, when the images of the positions P1-P5 are determined to be captured, the illumination periods PDi are aligned with the timings that the positions P1-P5 come to the spot to be illuminated. Thus, the positions P1-P5 can be illuminated. In addition, the detection periods PDd are aligned with the illumination periods PD, so as to ensure the image sensor 140 can receive the laser beam reflected from the positions P1-P5.

In some embodiments, the image sensor 140 is triggered by a trigger pulse TP. In some embodiments, the trigger pulse TP is issued externally.

The foregoing outlines features of several embodiments of the present application so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An optical inspection system, comprising:
an optical device, comprising:
a light source, configured to generate a first laser beam by performing a first non-linear harmonic generation and a second non-linear harmonic generation and direct the first laser beam through an illuminator to be an incident laser beam toward a wafer, so as to generate a reflected laser beam accordingly; and
an image sensor, configured to capture the reflected laser beam through an objective to be a second laser beam and generate an image of the wafer accordingly; and
an image processing device, configured to generate a detection result according to the image,
wherein a wavelength of the incident laser beam is less than 120 nm, wherein the wavelength of the first laser beam is adjustable,
wherein the first non-linear harmonic generation is performed in solid state material, and the second non-linear harmonic generation is performed in gas.

2. The optical inspection system of claim 1, wherein the incident laser beam is a pulsed lase, and the wavelength of the incident laser beam ranges from 50 to 120 nm.

3. The optical inspection system of claim 1, wherein the light source comprises:
a laser pump, configured to generate a source laser beam;
a central wavelength selector, configured to select a wavelength range from the source laser beam to generate a narrow band laser beam; and
a first harmonic generator, configured to perform the second non-linear harmonic generation to generate the first laser beam according to the narrow band laser beam.

4. The optical inspection system of claim 3, wherein the light source further comprises:
a second harmonic generator, configured to perform the first non-linear harmonic generation to convert the narrow band laser beam to be a deep ultraviolet (DUV) laser beam,
wherein the second non-linear harmonic generation is a third order non-linear generation, and the first non-linear harmonic generation is a second order non-linear generation.

5. The optical inspection system of claim 3, wherein a spectrum of the source laser ranges from 400 nm to 1100 nm, and the wavelength range selected by the central wavelength selector is ranging in visible light or in infrared light.

6. The optical inspection system of claim 1, wherein the first harmonic generator is operated in noble gas.

7. The optical inspection system of claim 1, wherein the optical device further comprises:
the illuminator; and
the objective,
wherein the illuminator comprises:
a collector, configured to collect and project the first laser beam to be a first beam;
a de-speckler, configured to receive the first beam and decrease a degree of coherence of the first beam to be a second beam;
a collimator, configured to collimate the second beam to be a third beam;
a homogenizer, configured to unify a light intensity of the third beam and shape the third beam to be a fourth beam;
a condenser, configured to condense the fourth beam to be a fifth beam; and
a relay, configured to adjust a numeral aperture of the fifth beam and relay the fifth beam to be the first laser beam.

8. The optical inspection system of claim 7, wherein the illuminator and the objective are catoptrics devices.

9. The optical inspection system of claim 7, wherein the objective comprises:
a first curved mirror;
a second curved mirror;
a first mirror; and
a second mirror,
wherein the reflected laser beam is guided to the image sensor sequentially through the first curved mirror, the second curved mirror, the first mirror, and the second mirror,
wherein the first curved mirror is a mirror cropped from a concave mirror of Schwarzschild objective, the second curved mirror is a mirror cropped from a convex mirror of Schwarzschild objective, and the first curved mirror and the second curved mirror collectively form a part of Schwarzschild objective.

10. The optical inspection system of claim 9, wherein the first curved mirror and the second curved mirror are aspherical mirrors.

11. The optical inspection system of claim 9, wherein an intermediate focus is formed between the second cured mirror and the first mirror.

12. The optical inspection system of claim 1, wherein the image sensor is implemented by a TDI sensor.

13. The optical inspection system of claim 1, further comprising:
a wafer stage, configured to bear the wafer;
a motion controlling device, configured to control the wafer stage to move the wafer along a predetermined inspection path; and
a spatial position measurement, configured to obtain a position of the wafer in a stage coordinate system.

14. The optical inspection system of claim 13, further comprising:
a position measurement module, configured to determine whether the wafer deviated from the predetermined inspection path according to the position of the wafer.

15. The optical inspection system of claim 13, further comprising:
a host computer, configured to set the predetermined inspection path.

16. The optical inspection system of claim 1, further comprising:
a synchronizing device, configured to synchronize a timing that the light source generating of the incident laser beam and a timing that the image sensor capturing the reflected laser beam.

17. An optical inspection system, comprising:
an optical device, comprising:
a light source, configured to generate a first laser beam by performing non-linear harmonic generations and direct the first laser beam through an illuminator to be an incident laser beam toward a wafer, so as to generate a reflected laser beam accordingly, wherein the light source comprises:
a first wavelength converting channel, configured to generate a first UV laser;
a second wavelength converting channel, configured to generate a second UV laser; and
an XUV generator, configured generate the first laser beam according to the first UV laser or the second UV laser; and
an image sensor, configured to capture the reflected laser beam through an objective to be a second laser beam and generate an image of the wafer accordingly; and
an image processing device, configured to generate a detection result according to the image.

18. The optical inspection system of claim 17, wherein the light source further comprises:
a laser unit, configured to generate a first IR laser;
a wave retarder, configured to adjust a polarization of the first IR laser to be a second IR laser; and
a spectrum shaper, is configured to filter a spectrum of the second IR laser and generate a third IR laser accordingly,
wherein the third IR laser are transmitter to the first wavelength converting channel and the second wavelength converting channel, and the first wavelength converting channel and the second wavelength converting channel respectively generate the first UV laser and the second UV laser according to the third IR laser.

19. The optical inspection system of claim 18, wherein the first wavelength converting channel comprises a first nonlinear process (NOP) unit and a second NOP unit, wherein the first NOP unit is configured to convert the third IR laser to a first visible laser and a fourth IR laser, and the second NOP unit is configured to generate a third UV according to first visible laser,
wherein the first UV laser is generated according to the third UV,
wherein the first NOP unit and the second NOP unit are operated in solid state material.

20. The optical inspection system of claim 17, wherein the XUV generator comprises:
a third NOP unit, configured to generate an XUV laser and a fourth UV laser according to the first UV laser; and
a wavelength separator, configured to separate the XUV laser from the fourth UV laser so as to generate the first laser beam,
wherein the third NOP unit is operated in noble gas.

21. The optical inspection system of claim 17, wherein the optical device further comprises:
the illuminator, comprises:
a collector, configured to collect and project the first laser beam to be a first beam;
a de-speckler, configured to receive the first beam and decrease a degree of coherence of the first beam to be a second beam;
a collimator, configured to collimate the second beam to be a third beam;
a homogenizer, configured to unify a light intensity of the third beam and shape the third beam to be a fourth beam;
a condenser, configured to condense the fourth beam to be a fifth beam; and
a relay, configured to adjust a numeral aperture of the fifth beam and relay the fifth beam to be the first laser beam; and
the objective, comprises:
a first curved mirror;
a second curved mirror;
a first mirror; and
a second mirror,
wherein the reflected laser beam is guided to the image sensor sequentially through the first curved mirror, the second curved mirror, the first mirror, and the second mirror,
wherein the first curved mirror is a mirror cropped from a concave mirror of Schwarzschild objective, the second curved mirror is a mirror cropped from a convex mirror of Schwarzschild objective, and the first curved mirror and the second curved mirror collectively form a part of Schwarzschild objective.
